(19) United States
(12) Patent Application Publication
(10) Pub. No.: US 2025/0132399 A1
(43) Pub. Date: Apr. 24, 2025

(54) Ferroelectric Separators for Suppressing Dendrites Growth in Rechargeable Batteries

(71) Applicant: Wisconsin Alumni Research Foundation, Madison, WI (US)

(72) Inventors: Xudong Wang, Middleton, WI (US); Yutao Dong, Madison, WI (US)

(21) Appl. No.: 18/381,855

(22) Filed: Oct. 19, 2023

(51) Int. Cl. H01M 10/42; H01M 50/426; H01M 50/434; H01M 50/451; H01M 50/489

(52) U.S. Cl. CPC H01M 10/4235; H01M 50/426; H01M 50/434; H01M 50/451; H01M 50/489

(57) ABSTRACT

A mesoporous piezoelectric or ferroelectric (FE) Al₂O₃/P(VDF-TrFE) membrane can actively suppress anode dendrites formation when used as a separator in rechargeable aqueous Zn-ion batteries. When the positive polarization side of the FE separator faces the metal anode during charging, the FE separator can reverse the local energetics for Zn²⁺ reduction at the protrusion area and deplete incoming Zn²⁺ ions to the flat region. As a result, the symmetric Zn—Zn cell with this P+ separator can achieve a substantially higher cycling stability.

### STATEMENT REGARDING FEDERALLY SPONSORED RESEARCH OR DEVELOPMENT

This invention was made with government support under DE-SC0020283 awarded by the US Department of Energy and under HL157077 awarded by the National Institutes of Health. The government has certain rights in the invention.

### CROSS REFERENCE TO RELATED APPLICATION

### Background of the Invention

The present invention relates to rechargeable batteries, and more particularly, to a membrane separator for rechargeable batteries positioned between a positively charged metal anode and a negatively charged cathode.

Rechargeable batteries are a critical component in the renewable and sustainable energy ecosystem. Driven by the tremendous global energy and environmental demands, battery technology is experiencing rapid developments toward the goal of high capacity, high cycling life, fast charging rate, and low cost batteries.

Among many emerging technologies, using metal anodes in rechargeable battery systems brings a beneficial advantage as they offer very high specific energy. However, a critical challenge for this type of rechargeable battery is the metal dendrites formation during the charging process, which results in poor cycling stability and quick capacity loss. Generally, when a small surface protrusion is developed on the anode surface, it concentrates an electrical field around the protrusion tip, forming an energy favorable site for metal ions to deposit and thus, accelerates the protrusion tip growth into dendrites. Thus, dendrites formation is an energetically favorable and self-aggravating process and can be found in all electrochemical metal ion deposition processes.

Because of this growth mechanism, many attempts have been made to suppress dendrites formation in rechargeable batteries. Existing strategies include anode engineering, electrolyte modification, and separator development: 1) An anode protective coating can homogenize the anode surface electric field and unify metal ion diffusion flux, designing three dimensional scaffold anodes to achieve a high specific surface area can eliminate current density inhomogeneity, and alloying the anode can improve charge transfer and modulate plating processes with alloying reactions; 2) Electrolyte modifications typically utilize high-concentration electrolytes and electrolyte additives to tune the metal ion coordination environment and improve ion migration; 3) Modified polymer separators can facilitate favorable metal ion diffusion and retard dendrites growth.

These strategies, in general, can slow down the dendrite growth rate to a certain level. However, since dendrite growth is still a thermodynamic favorable process, the growth cannot be eliminated completely. Further, these strategies are specific to different anode materials, structure, and electrolyte systems, limiting their impact to be applied to batteries more broadly.

### SUMMARY OF THE INVENTION

It has been shown that ferroelectricity can tune the surface energetics, and may reverse the electrochemical deposition selectivity. Inspired by this coupling effect, the present invention provides a mesoporous ferroelectric (FE) membrane as the battery separator that demonstrates an eradication of existing dendrites and dendrite growth.

The present invention is a mesoporous FE Al₂O₃/P(VDF-TrFE) membrane that can actively suppress anode dendrites formation when used as a separator in, e.g., rechargeable aqueous zinc (Zn)-ion batteries. When the positive polarization side of the mesoporous FE membrane faces the metal anode during charging, i.e., P+ configuration, the FE separator can reverse the local energetics for Zn²⁺ reduction at the protrusion area and deplete incoming Zn²⁺ ions to the flat regions of the anode. As a result, the symmetric Zn—Zn fuel cell with the P+ separator can achieve a substantially higher cycling stability compared to commercial glass fiber (GF) separators or compared to the same FE membranes but with different poling configuration.

A significantly flat and protrusion-less metal anode surface can be obtained from the P+ separator in Zn—Zn fuel cells after cycling, confirming the compete switch from dendritic growth to layered growth. A similar dendrite suppression effect was also demonstrated in Zn-NVO fuel cells, where the P+ separator enabled remarkable long-term stability compared to GF separators. These superior electrochemical performances confirmed the effectiveness of active dendrite suppression using FE polymer separators with a favorable polarization.

The present invention provides a promising strategy to achieve a dendrite-free anode, which could be applicable to other metal anodes in a wide range of rechargeable batteries, such as metal anodes of aluminum, brass, bronze, copper, lead, lithium, magnesium, nickel, silver, titanium, zinc and alloys of them.

Specifically, the present invention provides a battery comprising an anode; a cathode in opposition from the anode and communicating with the anode via an electrical conductor; and a separator separating the anode and the cathode wherein the separator is a mesoporous piezoelectric membrane of piezoelectric material extending along a plane and its polar direction is across the plane wherein the positive polarization is substantially facing the anode and the negative polarization is substantially facing the cathode.

It is thus a feature of at least one embodiment of the present invention to eliminate dendritic grown in metal anode fuel cells (e.g., aqueous or solid) which occurs during the charging process in batteries.

The piezoelectric membrane may be ferroelectric. The piezoelectric material may have a piezoelectric coefficient d33 value of 1-200 pC/N. The piezoelectric material may have a piezoelectric coefficient d33 value of 25 pC/N.

It is thus a feature of at least one embodiment of the present invention to utilize the polarized state of the ferroelectric separator material to induce an electric field favorable to decreasing metal ion accumulation at protrusion tips and increasing metal ion accumulation at flat regions of the metal anode surface.

The mesoporous membrane may be P(VDF-TrFE). The β-phase may be induced in the P(VDF-TrFE).

It is thus a feature of at least one embodiment of the present invention to utilize ferroelectric material common to battery separators to tune surface energetics and reverse electrochemical deposition selectivity.

The mesoporous piezoelectric membrane may comprise of nanopores having an opening size of 35-45 nm. The nanopores may be sized to permit the transport of liquid electrolyte and metal ions. The nanopores may be sized to permit the transport of Zn metal ions.

It is thus a feature of at least one embodiment of the present invention to allow for liquid electrolyte and metal ion transport across the separator membrane that is needed to close the circuit during the passage of current in an electrochemical cell.

The nanopores may be formed by nanoparticles with a weight ratio of 50-90 wt %. The nanopores may be formed by nanoparticles with a weight ratio of approximately 83 wt %.

It is thus a feature of at least one embodiment of the present invention to produce a 3D porous network with submicron-sized pores evenly distributed and interconnected throughout the entire thickness of the membrane.

The mesoporous piezoelectric membrane may have a thickness of 10-50 μm. The mesoporous piezoelectric c membrane may have a thickness of approximately 20 μm.

It is thus a feature of at least one embodiment of the present invention to keep the two electrodes apart to prevent electrical short circuits while also allowing the transport of metal ions.

The mesoporous piezoelectric membrane may be coated with Al₂O₃.

It is thus a feature of at least one embodiment of the present invention to permit the mesoporous piezoelectric membrane to be adaptable for aqueous battery using a water-based solution as an electrolyte.

The anode may comprise protrusions extending from the anode toward the cathode.

It is thus a feature of at least one embodiment of the present invention to eliminate metallic microstructures that form on the negative electrode during the charging process formed when extra metal ions accumulate on the anode surface and cannot be absorbed into the anode in time.

The anode may be Zinc. The cathode may be a sodium vanadium oxide (NaV₃O₈, NVO) nanowire.

It is thus a feature of at least one embodiment of the present invention to permit the mesoporous piezoelectric membrane to be used with commercially available rechargeable battery anode and cathode materials.

In an alternative embodiment of the present invention a method of suppressing dendrite growth of a battery with an anode, a cathode in opposition from the anode and communicating with the anode via an electrical conductor, and a separator separating the anode and the cathode wherein the separator is a mesoporous piezoelectric membrane extending along a plane and poled across the plane wherein the positive polarization is substantially facing the anode and the negative polarization is substantially facing the cathode, the method comprising: producing an internal electric field near protrusion tips extending toward the cathode surrounded by flat regions of the anode; repulsing metal ions at the protrusion tips to the flat regions of the anode; and reducing the growth rate of protrusion tips and increasing a growth rate at the flat regions.

It is thus a feature of at least one embodiment of the present invention to prevent dendrite growth on the anode surface, i.e., dendrites growth prevention, during charging.

The mesoporous piezoelectric membrane may be ferroelectric. The method may include poling the separator to achieve aligned electrical polarization.

In an alternative embodiment of the present invention a method of suppressing dendrite growth of a battery with an anode, a cathode in opposition from the anode and communicating with the anode via an electrical conductor, and a separator separating the anode and the cathode wherein the separator is a mesoporous piezoelectric membrane extending along a plane and poled across the plane wherein the positive polarization is substantially facing the anode and the negative polarization is substantially facing the cathode wherein the anode exhibits inhomogeneity, the method comprising: producing an internal electric field near extrusions extending toward the cathode surrounded by flat regions of the anode; repulsing metal ions at the extrusions to the flat regions of the anode; and reducing the extrusions and increasing the homogeneity of the anode.

It is thus a feature of at least one embodiment of the present invention to eliminate dendrite growth already formed on the anode surface, i.e., dendrites “self-healing” during charging.

The mesoporous piezoelectric membrane may be ferroelectric. The method may include poling the separator to achieve aligned electrical polarization.

These particular objects and advantages may apply to only some embodiments falling within the claims and thus do not define the scope of the invention.

### BRIEF DESCRIPTION OF THE DRAWINGS

FIG. 1 is a schematic of the mechanism of active dendrite suppression by the ferroelectric (FE) membrane of the present invention in a rechargeable Zn-ion battery setup;

FIG. 2 is a schematic of the electric potential and Zn²⁺ concentration (C_{Zn2+}) distributions at the protrusion area during the charging process;

FIG. 3 is a cross-sectional SEM image of a porous P(VDF-TrFE) membrane and, inset, a digital photo of a P(VDF-TrFE) membrane with a diameter of 16 mm for battery assembly;

FIG. 4 are enlarged SEM images of a P(VDF-TrFE) membrane before (A) and after (B) Al₂O₃ ALD coating showing the interconnected submicron-sized pores;

FIG. 5 are water contact angle comparisons between pristine P(VDF-TrFE) membrane (top) and Al₂O₃/P(VDF-TrFE) membrane (bottom);

FIG. 6 is a schematic of a procedure for fabricating mesoporous piezoelectric P(VDF-TrFE) thin films in accordance with a first embodiment of the invention;

FIG. 7 is a schematic of the procedure of preparing for fabricating mesoporous piezoelectric P(VDF-TrFE) thin films in accordance with a second embodiment of the invention;

FIG. 8 are XPS spectra of P(VDF-TrFE) (top) and Al₂O₃/P(VDF-TrFE) (bottom) membranes;

FIG. 9 is XRD spectra of P(VDF-TrFE) membranes before (circles) and after (triangles) Al₂O₃ ALD coating;

FIG. 10 is a polarization-electric field (P-E) hysteresis loop measured from as-prepared porous P(VDF-TrFE) membrane (A) and Al₂O₃/P(VDF-TrFE) membrane (B) at room temperature;

FIG. 11 is a schematic setup of P+ and P− FE membrane separators for Zn electrodeposition on Zn metal surface;

FIG. 12 are EFM measurements of P+(top) and P− (bottom) FE membranes fixed on Zn plates at protrusion areas; left are topography images and right are EFM amplitude images;

FIG. 13 are surface morphology (top) and large-area roughness (bottom) of Zn metal sheets after Zn electrodeposition for 10 h under 1 mA/cm² used with separators of P+FE membrane (A), P− FE membrane (B), GF separator (C), and UP FE membrane (D);

FIG. 14 are surface morphology (left) and large-area roughness (right) of an extremely rough Zn surface sheets (A) after additional 10 h Zn electrodeposition using a P+FE membrane separator (B) showing a substantial recovery of surface smoothness;

FIG. 15 are voltage profiles at a current density of 1 mA/cm² to the specific capacity of 1 mAh/cm², and enlarged voltage profiles at different cycling time points;

FIG. 16 are top-view SEM images of the Zn anode surface after cycling used with separators of P+ FE membrane (A), GF separator (B), UP FE membrane (C), and P− FE membrane (D);

FIG. 17 are (A) cyclic voltammetry plot at a scan rate of 0.1 mV/s, (B) Nyquist EIS plots of Zn-NVO fuel cells, (C) Rate capabilities of Zn-NVO fuel cells at various current densities, (D, E) Long-term cycling performance of Zn-NVO fuel cells at 2 A/g (D) and 5 A/g (E); and

FIG. 18 are top-view SEM images of Zn anode after 4000 cycles at 2 A/g with GF separator (A) and P+FE separator (B), (C, D) Top-view SEM images of Zn anode after 6000 cycles at 5 A/g with GF separator (E) and P+FE separator (F).

### DETAILED DESCRIPTION OF THE PREFERRED EMBODIMENT

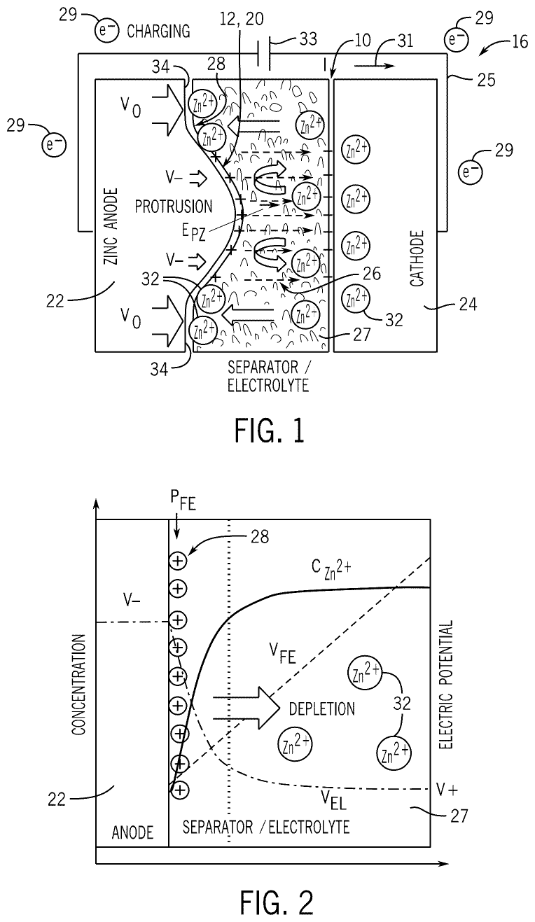

Referring to FIGS. 1 and 2, a mesoporous ferroelectric (FE) Al₂O₃/P(VDF-TrFE) membrane 10 can actively suppress anode dendrites 12 formation when used as a separator in rechargeable aqueous Zn-ion batteries 16.

The mechanism of using a FE separator membrane 10 to suppress anode dendrite 12 formation is schematically shown in FIG. 1 using, in one embodiment, a typical Zn-ion battery 16. The Zn-ion battery 16 for use with the present invention has an anode 22 electrically communicating with a cathode 24 via an electrical conductor 25, the anode 22 and cathode 24 separated by the FE separator membrane 10 and submerged within an electrolyte solution 27. The electrolyte solution 27 may be water, soluble salts such as sodium chloride, acids or bases in liquid, and other solvents in gelled and dry formats. When the anode 22 is oxidized by dissolving (i.e., undergoes an oxidation reaction) in the electrolyte solution with OH⁻ ions, the anode 22 produces free electrons 29 and metal ions or Zn²⁺ ions 32 that are dissolved in the electrolyte solution 27. The free electrons 29 pass from the anode 22 to the cathode 24 through the electrical conductor 25 to produce an electrical current 31, which can be used to power an external load 33. The external load 33 may be an electronic device. The Zn²⁺ ions 32 pass from the anode 22 to the cathode 24 through the electrolyte solution 27 and the FE separator membrane 10.

Normally, during the charging process (e.g., a metal plating process), any non-homogeneity in the anode 22 can induce surface topographic fluctuations, which evolve into protrusions 20 over time or after more cycles. As the protrusions 20 extend, it compresses the separator membrane 10 that is sandwiched in between the metal anode 22 and cathode 24 materials.

The ferroelectric property of the FE separator membrane 10 can introduce an internal electric field (E_{FE}) 26 at the compressed region. The FE separator membrane 10 may be a hard or soft material with a piezoelectric coefficient d33 value of 1-200 pC/N or 25 pC/N. When the FE separator membrane 10 has its positive polarization (P_{FE}) 28 (opposite negative polarization 38) facing the metal anode electrode surface 22, the local electric potential at the protrusion tip 30 is elevated, turning it into an energy unfavorable site for reduction of metal ions as seen in FIG. 2. Meanwhile, the internal E_{FE} 26 also depletes the positively charged metal ions 32 in the electrolyte adjacent to the protrusion 20 surface. However, both E_{FE}-related effects do not apply to flat regions 34 where the FE separator membrane 10 is not compressed. Therefore, the protrusion 20 area will exhibit a reduced growth rate compared to the flatter regions 34 and thus, flatten the metal anode electrode surface 22 as the charging cycle progresses.

After cycling, the Zn metal anode 22 with a uniform and flat surface can be visualized by SEM and 3D optical profilometer, indicating a layer-like Zn growth behavior. After being assembled in Zn-NVO fuel cells 16, the P+ separator membrane 10 enables significant long-term stability over 6000 cycles with a 64% retention rate at 5 A/g and a specific capacity of ˜54 mAh/g after cycling. These superior electrochemical performances demonstrate the effectiveness of this P+ separator membrane 10 to suppress dendrite growth versus a commercial glass fiber (GF) separator. Alternatively, the symmetric Zn—Zn fuel cell 16 with this P+ separator membrane 10 can achieve ˜980 h cycling stability under a current density of 1 mA/cm² with a specific capacity of 1 mAh/cm².

In summary, when the positive polarization side faces the metal anode 22, i.e., P+ configuration, the Al₂O₃/P(VDF-TrFE) separator membrane 10 can provide an internal electric field near the protrusion 20 sites, repulsing incoming Zn²⁺ ions 32 to the flat region 34. The present invention provides a promising strategy to achieve a dendrite-free anode 22 by ferroelectric separator membranes 10 as well as other metallic anodes 22, substantially advancing the development of rechargeable batteries 16.

### Materials and Methods

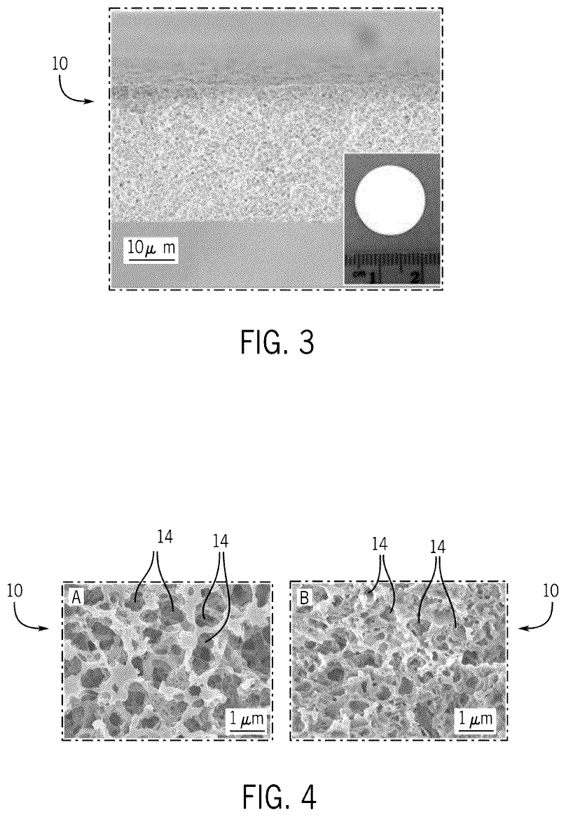

Referring to FIGS. 3 and 4A, the FE battery separator membrane 10 may be developed using mesoporous P(VDF-TrFE) separator membranes 10. Microscopic pores 14 are created throughout the membrane using, e.g., the ZnO nanoparticle (NP)-based hard-template method followed by hydrochloride (HCl) etching as described in the following examples. The microscopic pores 14 are between 10 nm to 10 μm or between 10 nm-50 nm in opening size and between 35 nm-45 nm in opening size. The produced membrane has a uniform thickness of 10-50 μm and of 10-30 μm and approximately 20 μm, similar to the thickness of commercial separators.

In producing the separator membrane, the ZnO NP weight ratio is 50 wt % to 90 wt % and at least 60 wt % and at least 70 wt % and at least 80 wt %. At an optimized ZnO NP weight ratio of 83.3 wt %, the P(VDF-TrFE) separator membrane 10 achieves a 3D porous network with submicron-sized pores evenly distributed and interconnected throughout the entire thickness as seen in FIG. 4A, suggesting a favorable environment for electrolyte transport. It is understood that the nanoparticles may be chosen to produce microscopic pores 14 which allow for metal ion transport through the P(VDF-TrFE) separator membrane 10.

It is understood that other FE or piezoelectric or composite battery separator membrane 10 materials may be used with the present invention. Examples of other FE, piezoelectric or composite battery separators membrane 10 materials which may be used include polyvinylidene fluoride (PVDF), polyvinylidene fluoride hexafluoropropylene (PVDF-HFP), ferroelectric particle imbedded polymer film (e.g. KNN in PVDF, BaTiO3 in Polylactic acid, etc.), amino acids, cellulose, and poly(L-lactic acid) (PLLA).

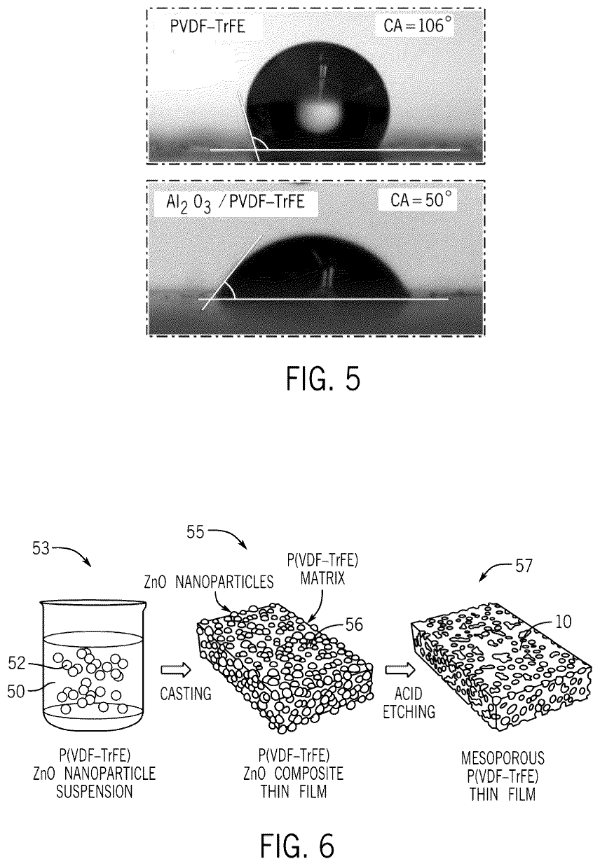

Referring to FIGS. 4B and 5, to achieve the desired hydrophilicity for aqueous battery systems, the pristine P(VDF-TrFE) separator membrane 10 may be optionally coated with a conformal thin film of Al₂O₃ by atomic layer deposition (ALD). After 70 nm ALD Al₂O₃ coating at 100° C., the Al₂O₃/P(VDF-TrFE) separator membrane 10 preserves the original high porosity without any apparent change as seen in FIG. 4B. The Al₂O₃ coating largely improves the film's hydrophilicity as evidenced by a substantial reduction of the water contact angle from 106° (top) to 50° (bottom) as seen in FIG. 5. It is understood that other hydrophilic thin films may be used with the present invention. Examples of other hydrophilic thin films which may be used include ZnO, TiO₂, SiO₂. In an alternative embodiment, oxygen plasma treatment may be used to turn the surface of the separator membrane 10 to hydrophilic.

Referring again to FIG. 1, the porous FE Al₂O₃/P(VDF-TrFE) separator membrane 10 is polarized by an external electric field. The poling process aligns the randomly dispersed dipole domains to achieve aligned ferroelectricity in the Al₂O₃/P(VDF-TrFE) separator membrane 10.

In the construction of the Zn-ions aqueous batteries 16, the polarized membrane 10 is arranged so its positive polarization (P_{FE}) 28 (opposite negative polarization 38) faces the metal anode 22 surface, i.e., P+ configuration. P+FE Al₂O₃/P(VDF-TrFE) separator membrane 10 may be used in Zn-ions aqueous batteries 16. It is understood that other anode materials 22 may be used with the present invention. Examples of other anode materials 22 which may be used include aluminum, brass, bronze, copper, lead, lithium, magnesium, nickel, silver, titanium, zinc and alloys of them.

In one embodiment of the present invention, NaV₃O₈·1.5H₂O (NVO) nanowires, a commonly used cathode material 24 for Zn-ion batteries 16, may be selected and coupled with the Zn foil anode 22 to assemble the fuel cells 16. It is understood that other cathode materials 24 may be used with the present invention. Examples of other cathode materials 24 which may be used include manganese-based oxide, vanadium-based materials, Prussian blue analogues, organic compounds, polyanionic compounds, and the like.

The following are exemplary embodiments of the present invention and do not limit the scope of the invention.

### Example 1

Preparation of porous P(VDF-TrFE) membranes: P(VDF-TrFE) powder (PolyK Technologies) was dissolved in N, N-Dimethylformamide (DMF) solvent (50 mg/L) at room temperature for 12 h and then ZnO nanoparticles (NPs) (35-45 nm, US Research Nanomaterials, Inc.) was added to P(VDF-TrFE)/DMF solution with different weight ratios of ZnO: P(VDF-TrFE). The weight ratios used were 50 wt %, 83.3 wt % and 90 wt %. In a preferred embodiment, the weight ratio was between 50 wt %-90 wt % and a weight ratio of 83.3 wt % yielded a continuous 3D interconnected porous structure.

The ZnO/P(VDF-TrFE)/DMF mixture was stirred for 12 h to obtain uniform suspension. The suspension was cast onto the glass slide and dried in the atmosphere at 60° C. Then, the membrane was immersed in 37 wt % HCl solution for 12 h to completely remove the ZnO NPs. After acid treatment, the membrane was immersed in deionized water and dried in the oven at 60° C. to obtain porous P(VDF-TrFE) membrane.

Atomic layer deposition (ALD) of Al₂O₃: To improve the hydrophilicity of the P(VDF-TrFE) membranes, an amorphous Al₂O₃ layer was introduced to porous P(VDF-TrFE) film by homemade atomic layer deposition (ALD). Al₂O₃ ALD was conducted at 100° C. with the precursors of trimethylaluminum (TMA) and H₂O. The pulsing time of TMA is 60 s and of H₂O is 0.5 s and separated by 60 s N₂ purging. A total of 70 cycles of ALD were implemented to achieve hydrophilic porous Al₂O₃/P(VDF-TrFE) membrane.

Polarize the ferroelectric (FE) Al₂O₃/P (VDF-TrFE) membranes: An as-prepared Al₂O₃/P(VDF-TrFE) membrane was sandwiched between two parallel 50 nm Au-coated glass slides and immersed in dimethylpolysiloxane (viscosity 5 cSt, 25° C.). 3 kV direct voltage was applied to the membrane in two opposite directions for 2 hours (notated as P+ and P−). This poling process was to align randomly dispersed dipole domains to achieve aligned ferroelectricity in the Al₂O₃/P(VDF-TrFE) membrane. After poling, the membrane was washed with cyclohexane and ethanol to remove physisorption dimethylpolysiloxane to ensure acceptable hydrophilicity of the Al₂O₃/P(VDF-TrFE) membrane for aqueous Zn-ions batteries separator.

Preparation of NaV₃O₈·1.5H₂O (NVO) battery cathode: 0.5 g of commercial V₂O₅ powder (Sigma-Aldrich, Inc.) was added to 20 mL of 2 M NaCl aqueous solution. The yellow suspension was stirred for 4 days under 30° C. The obtained red suspension was centrifuged at 5000 rpm for 5 mins and the dark-red product was washed with deionized water and ethanol and dried in the oven at 60° C. for overnight. The NVO cathode was prepared by mixing NVO powder active materials, acetylene black carbon conductive additive, and (polyvinylidene difluoride) PVDF binder in a weight ratio of 7:2:1. The mass loading of active materials was ˜3.0 mg/cm².

Structure Composition Analysis: Scanning Electron Microscopy (SEM) images and Energy-dispersive X-ray Spectroscopy (EDS) mappings were captured on a Zeiss LEO1530 field-emission microscope. X-ray Diffraction (XRD) patterns were obtained on the Bruker D8 Discovery with Cu Kα radiation. The X-ray Photoelectron Spectroscopy (XPS) spectrum was acquired using a Thermo Scientific K-alpha XPS instrument with a flood gun on in 400 μm spot size. Contact Angle tests were conducted on Dataphysics OCA 15 Optical Contact Angle Measuring System. 3D surface profiling imaging was performed on Zygo 9000 Optical Profilometer.

Dipole & Piezoelectricity Analysis: The polarization-electric field (P-E) curve of the FE Al₂O₃/P(VDF-TrFE) membrane was measured using a precision material analyzer (Premier II, Radiant Technologies Inc., Albuquerque, NM, USA). The direct piezoelectric d33 coefficients of polarized Al₂O₃/P(VDF-TrFE) membrane were measured using a quasistatic d33 piezometer (ZJ-3A, Institute of Acoustics, Chinese Academy of Sciences, Beijing, China). Electrostatic Force Microscopy (EFM) was applied to investigate the surface potential distribution of a FE Al₂O₃/P(VDF-TrFE) membrane compressed by Zn dendrite protrusions using an XE-70 Park System. In this measurement, the Zn dendrites were created by electroplating under 10 mA/cm² for 1 h. The scanning area was 5×5 μm².

Electrochemical Measurements: 50 μm-thick Zn foil (Sigma-Aldrich, Inc.) was used as the metal anode, and four different membranes (GF, NP, P+, P−) were used as the separators for Zn electroplating, Zn—Zn symmetric cells, and Zn-NVO fuel cells. Zn electroplating was performed in a 2 M ZnSO₄ aqueous solution under 1 mA/cm² current density for 10 hours to observe Zn dendrites growth with various separator membranes. CR2016 coin cells were applied to assemble both Z—Zn symmetric cells and Zn-NVO fuel cells to measure the electrochemical performance. Symmetric Zn—Zn cells were composed of two bare Zn foils with 1 M ZnSO₄ as electrolyte. For Zn-NVO full cell, 0.1M Na₂SO₄ was added in 1 M ZnSO₄ aqueous solution as the electrolyte. Cyclic voltammetry was conducted on Autolab PGSTAT302N Potentiostat in the voltage range of 0.3-1.6 V at a scan rate of 0.1 mV/s. Electrochemical impedance spectroscopy was obtained from an Autolab PGSTAT302 N in the frequency range of 100000-0.1 Hz at an open circuit potential (OCP) condition. Long-term cycling performance at different current densities was performed on a Lanhe-2100 battery tester.

### Example 2

### Preparation of Porous P(VDF-TrFE) Membranes

Referring to FIG. 6, the mesoporous P(VDF-TrFE) separator membrane 10 was fabricated by casting a mixture of P(VDF-TrFE)/DMF solution 50 and ZnO nanoparticles (NPs) 52, as shown in step 53, onto a flat surface, as shown in step 55, to form a P(VDF-TrFE)/ZnO composite thin film 56, followed by HCl acid solution etching to remove the ZnO, as shown in step 57, to form a porous P(VDF-TrFE) separator membrane 10. HCl solution was selected because P(VDF-TrFE) is a hydrophobic polymer with excellent chemical stability against corrosive solvents including acids.

Introducing ZnO NPs 52 to P(VDF-TrFE)/DMF solution 50 has two purposes: 1) to create porosity in the P(VDF-TrFE) separator membrane 10 to allow for electrolyte transport and 2) to seed the formation of the piezoelectric β-phase. Additionally, ZnO has several unique advantages compared to other inorganic (e.g., SiO₂) or organic (e.g., polystyrene) NP templates for the fabrication of porous nanomaterials, including low-cost, non-toxicity, good scalability, and facile removal by acidic solution.

Scanning electron microscopy (SEM) images show the sponge-like mesoporous structure of the P(VDF-TrFE) separator membrane 10 after removing ZnO NPs 52. The pore sizes are consistent with those of the ZnO NPs 52 (i.e., 35-45 nm in average). The pores are interconnected allowing ZnO NPs 52 to be completely removed via chemical etching. This was evidenced by the energy dispersive X-ray spectroscopy (EDS) spectrum where only C and F elements were detected.

Fourier transform infrared (FTIR) spectrum was used to confirm the crystal phase of the mesoporous P(VDF-TrFE) separator membrane 10. The characteristic peaks of the j-phase at 509, 840 and 1280 cm⁻¹ can be clearly observed in the FTIR spectrum. The formation of β-phase P(VDF-TrFE) can be attributed to the interactions between the P(VDF-TrFE) dipoles and surface charges on ZnO surfaces. In wurtzite ZnO crystals, the (0001) surfaces are terminated with Zn cations and always positively charged, while the (0001) surfaces are O-terminated and exhibit negative charges. The intrinsic ZnO polar surfaces could interact with the P(VDF-TrFE) CF₂ or CH₂ groups that have negative and positive charge densities, respectively, and thus initiated the j-phase nucleation. This mechanism is consistent with the surface charge-induced crystallization phenomenon that has been discovered in many PVDF composites with fillers such as BaTiO₃, clays, hydrated ionic salts, polymethylmethacrylate (PMMA), TiO₂, ferrite, Pd, Au, and carbon nanotubes.

Using this method, a large-area mesoporous P(VDF-TrFE) separator membrane 10 (18.5 cm in diameter) was fabricated, demonstrating the capability of producing high quality piezoelectric polymer thin films in large scales. The film thickness can be facilely adjusted by the amount of casting mixture.

A method of making P(VDF-TrFE) separator membrane 10 is described in U.S. Pat. No. 9,444,030, entitled “Nanoporous Piezoelectric Polymer Films for Mechanical Energy Harvesting,” filed May 10, 2013, also assigned to the present assignee; and Mao, Yanchao & Zhao, Ping & McConohy, Geoff & Yang, Hao & Tong, Yexiang & Wang, Xudong. (2010). Sponge-Like Piezoelectric Polymer Films for Scalable and Integratable Nanogenerators and Self-Powered Electronic Systems. Advanced Energy Materials. 4. 10.1002/aenm.201301624, by the present inventors, each of which is hereby incorporated by reference.

### Example 3

### Preparation of Porous P(VDF-TrFE) Membranes

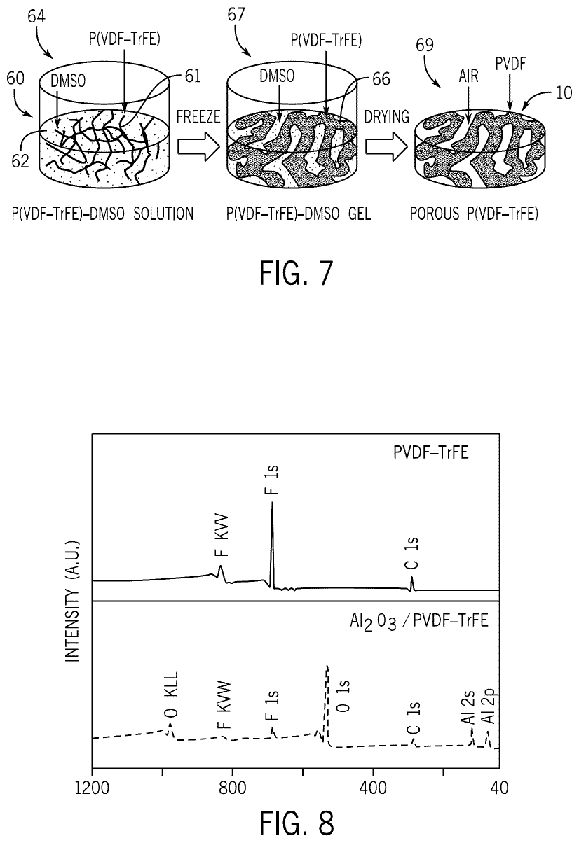

Referring to FIG. 7, the mesoporous P(VDF-TrFE) separator membrane 10 was fabricated by a sol-gel method and the fabrication process schematically illustrated in FIG. 7.

A P(VDF-TrFE)/DMSO solution 60 was prepared by mixing P(VDF-TrFE) powder (PolyK Technologies) and crosslinker (Sylgard184, Dow Corning) with a 20:1 weight ratio. The P(VDF-TrFE) 61 was dissolved in dimethyl sulfoxide (DMSO) 62 at 70° C. under vigorous stirring to form a homogeneous solution 64, as shown in step 65. The amount of P(VDF-TrFE) was weighted from 3% to 15% of the total mass. The solution 64 was then stored at 12° C. for 2 h to form a gel 66, as shown in step 67. Drying the P(VDF-TrFE)/DMSO gels 66 in vacuum (0.8 Pa) at room temperature (18-25° C.) completely removed DMSO 62 and yielded a mesoporous P(VDF-TrFE) network, as shown in step 69.

The P(VDF-TrFE) separator membrane 10 with 4% P(VDF-TrFE) exhibited an interconnected network feature with observable pore size from nearly 1 μm to 100 nm. Through this approach, P(VDF-TrFE) separator membrane 10 may be fabricated with a wide range of P(VDF-TrFE) volume ratio from 3% to 18%.

This fabrication strategy is very simple and advantageous in effectively producing high-porosity P(VDF-TrFE) separator membrane 10 without using any templates. Compared to other regularly used solvents, such as N,N-dimethylformamide, N,N-dimethylacetamide (DMAc), and acetone, DMSO has higher melting point, and thus the P(VDF-TrFE)/DMSO gel 66 could remain solid at relatively high temperature allowing DMSO 62 to be removed via sublimation in vacuum. Absence of the liquid phase eliminated the capillary force during drying, and thereby significantly suppressed the gel network shrinkage and well preserved the porous structure.

A method of making P(VDF-TrFE) separator membrane 10 is described in Zhang, Zhiyi & Yao, Chunhua & Yu, Yanhao & Hong, Zhanglian & Zhi, Mingjia & Wang, Xudong. (2016). Mesoporous Piezoelectric Polymer Composite Films with Tunable Mechanical Modulus for Harvesting Energy from Liquid Pressure Fluctuation. Advanced Functional Materials. 36. 10.1002/adfm.201602624, by the present inventors, hereby incorporated by reference.

### Results and Discussion

Referring to FIG. 8, x-ray photoelectron spectroscopy (XPS) was performed for elemental analysis before and after ALD Al₂O₃ coating. The XPS survey spectrum of pristine P(VDF-TrFE) separator membrane 10 (upper curve in FIG. 8) clearly showed F 1 s (688.8 eV) and C 1 s (291.08 eV) peaks without any Zn peaks, confirming the complete removal of ZnO NPs by HCl etching. After Al₂O₃ coating, the XPS survey (lower curve in FIG. 8) showed strong Al 2 s (119.08 eV) and 2p (74.08 eV) peaks and the F 1 s (688.08 eV) peak intensity was largely reduced. Energy-dispersive X-ray Spectroscopy (EDS) mappings of the Al₂O₃/P(VDF-TrFE) separator membrane 10 from the cross-sectional view revealed a complete overlap of the Al and O signal distributions with that of F, evidencing a uniform coating of Al₂O₃ throughout the entire membrane thickness.

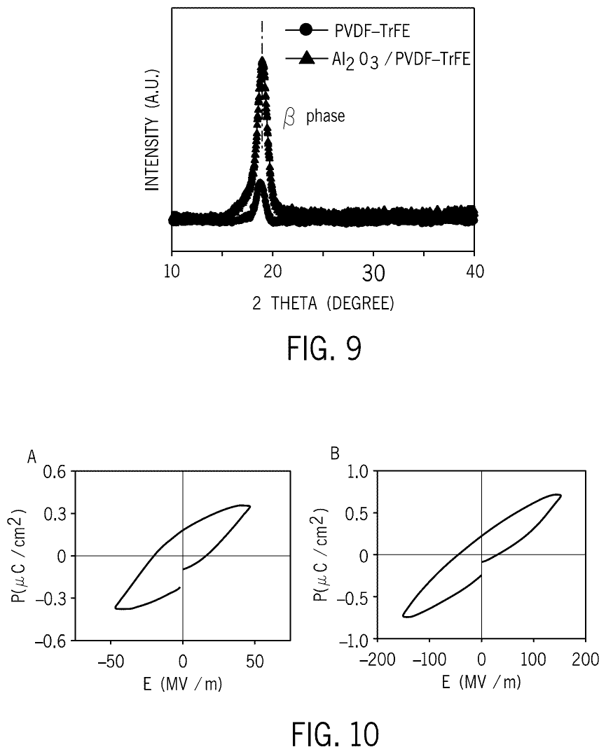

Referring to FIGS. 9 and 10, to confirm the ferroelectricity, the phase of the Al₂O₃/P(VDF-TrFE) separator membrane 10 was characterized by X-Ray Diffraction (XRD). The strong diffraction peak at 18.9° in both pristine and Al₂O₃-coated P(VDF-TrFE) membranes confirmed their FE R phase (FIG. 9). The increased diffraction intensity after ALD coating may be attributed to the further improved crystallinity after thermal annealing during the ALD process. Both membranes showed an apparent residual polarization in their polarization versus electric field (P-E) measurements (FIG. 10), where the Al₂O₃-coated membrane exhibited a substantially stronger hysteresis, consistent with its higher R phase crystallinity. Directed by the hysteresis measurement, the Al₂O₃/P(VDF-TrFE) separator membranes 10 were poled at ˜1.5 MV/cm to achieve aligned electrical polarization and permanent ferroelectricity. After 2 hours of poling, the d33 value of the poled Al₂O₃/P(VDF-TrFE) separator membranes 10 was measured to be approximately 2.8 pC/N, validating the effective dipole alignment and appreciable polarization generated from film displacement.

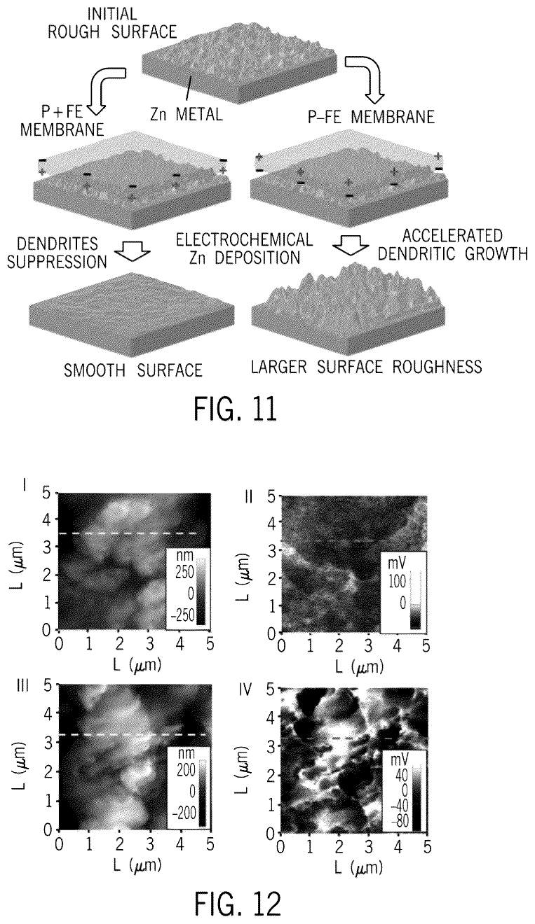

Referring to FIGS. 11 and 12, the active dendrite suppression mechanism suggests that the direction of FE polarization is critical, and the dendrites can only be eliminated when the FE membrane has its positive polarization facing the metal surface. This configuration is defined as P+. If the FE membrane has its negative polarization facing the electrode surface (defined as P−), protrusions may lead to accelerated tip growth, and thus more substantial dendrite formation as seen in FIG. 11. The protrusion-induced surface polarization change was first evidenced by electrostatic force microscopy (EFM) on the top surface of the FE membrane that tightly covered protruded areas as seen in FIG. 12. Around the protrusion tip where the membrane subjected the largest compressive force, the P+ membrane showed a depletion of positive surface charge on its back side, as represented by the negative amplitudes, indicating the other side facing the metal surface was positively charged. In contrast, the P− membrane showed an accumulation of positive charges at the protrusion area. The opposite charge accumulation in response to protrusion-induced compressive force confirmed that the metal-facing surface of P+ and P− membranes were charged positively and negatively, respectively.

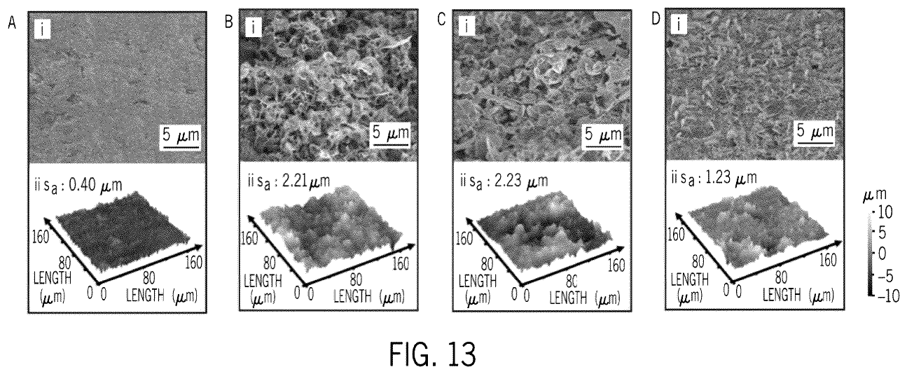

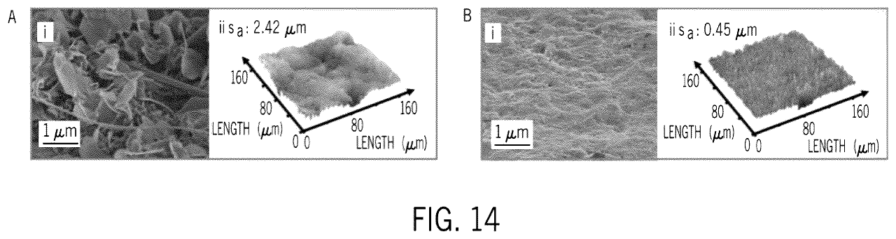

Referring to FIGS. 13 and 14, the active dendrites suppression effect was then verified using Zn foils paired with four different membranes (P+, P− and unpoled (UP) P(VDF-TrFE) and commercial glass fiber (GF)) for Zn electroplating in a 2 M ZnSO₄ aqueous solution at 1 mA/cm². After 10 h of electrodeposition, the Zn foil with P+ membrane exhibited a distinct surface morphology compared to the others. As shown in FIG. 13A-i, the Zn foil surface was homogenous and almost featureless. The large-area 3D surface profile revealed the excellent surface flatness, with a mean height (Sₐ) of only ˜0.40 μm (FIG. 13A-ii). The P− membrane yielded a complete opposite result, where large and irregular Zn flakes and whiskers were dominating the Zn foil surfaces (FIG. 13B-i) giving a dramatic surface roughness with a Sₐ of ˜2.21 μm (FIG. 13B-ii). This deposition result was similar to those obtained from the commercial GF membranes (FIG. 13C-i), which had a very close Sₐ of ˜2.23 μm (FIG. 13C-ii). For the case of UP membrane, the Zn foil surface was also completely covered by micron-sized flakes but with a more regular distribution (FIG. 13D-i). Thus, the surface roughness of Zn foil was in between those obtained from P+ and P− membranes with a Sₐ of ˜1.23 μm (FIG. 13D-ii). This result is consistent with hypothesized mechanism that opposite FE polarizations at the Zn surface can impose opposite influences to the protrusion growth rates.

Such drastic differences in the electrodeposition behavior appeared as soon as the surface protrusions become prominent at the early stage (e.g. 1 hour, FIG. 14A). This mechanism thus can be considered as a self-healing effect for dendrites annihilation. As a demonstration, the very rough Zn foil after 10 h electrodeposition using a GF membrane (FIG. 13D) was used with a P+ membrane for another 10 h electrodeposition. Notably, the dendritic surface was substantially flattened (FIG. 14B) and the Sa of Zn foil decreased from 2.42 to 0.45 μm accordingly. This result provides a strong support to the proposed active dendrites suppression mechanism, i.e., the self-regulated surface electric field distribution can recalibrate the metal ion deposition rates and actively flatten the electrode surface.

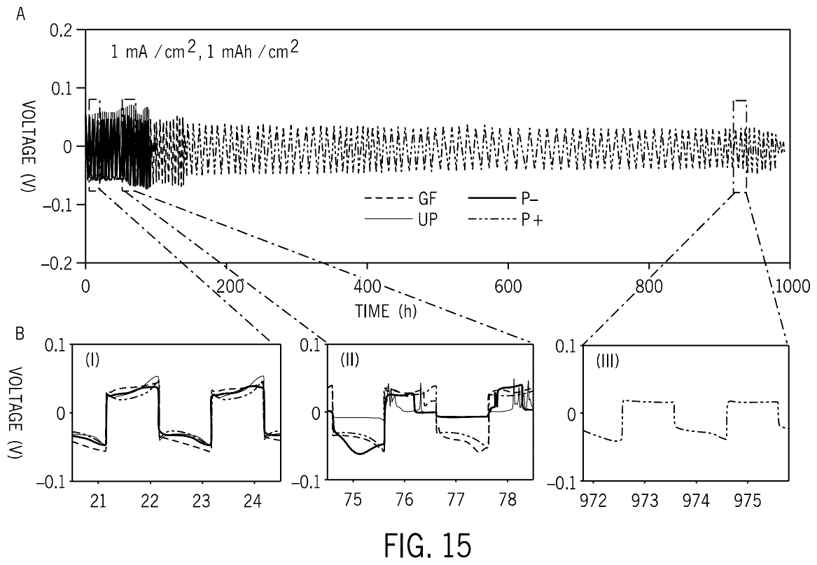

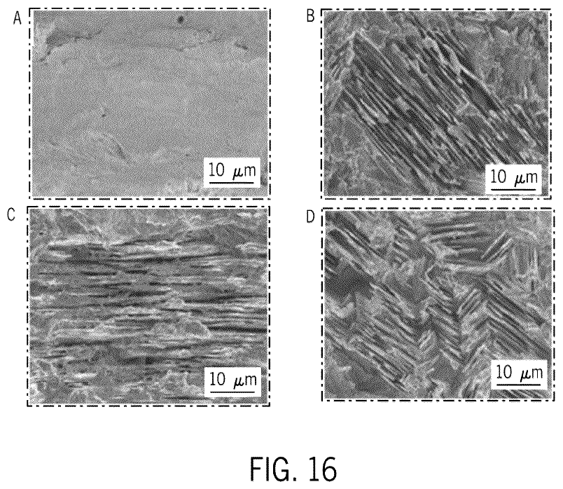

Referring to FIG. 15, the active dendrite suppression effect was then investigated using symmetric Zn—Zn cells, assembled with those four different membranes as the separator for galvanostatic cycling measurements. As displayed in FIG. 15A, the Zn—Zn symmetric cells were discharging/charging at 1 mA/cm² with a specific capacity of 1 mAh/cm². The cell with P+ FE separator exhibited a stable cycling lifetime of ˜980 h. Without any further optimization, this lifetime already reached the best-reported lifetime of Zn—Zn cells using ZnSO₄ aqueous electrolyte (Table 1). All the other three separators gave substantially shorter lifetimes. Specifically, the Zn—Zn cell with a GF separator showed a lifetime of ˜100 hours, comparable to the reported results.

TABLE 1
Zn—Zn symmetric cell cycling lifetime
comparison with literature values.

| | Current | | |
|---|---|---|---|
| | Density | Cycling Capacity | Cycle life |
| Separator | (mA/cm²) | (mAh/cm²) | (h) |
| Al₂O₃/P(VDF-TrFE) | 1 | 1 | 980 |
| Mixed cellulose ester | 1 | 1 | 700 |
| (MCE) | | | |
| g-C₃N₄/GF | 1 | 1 | 600 |
| VG@GF | 1 | 1 | 250 |
| CT@NZF@N | 0.5 | 0.5 | 300 |
| Lignin@Nafion | 0.6 | 0.3 | 410 |
| GF/GO1 | 0.5 | 0.25 | 500 |
| rGO/ZrMOF/PP/PE | 0.5 | 0.25 | 500 |

Referring to FIGS. 15 and 16, the voltage curve profiles at different cycling time points were enlarged to compare the Zn plating/stripping dynamics. The voltage hysteresis of the P+ separator was much lower than those of GF, UP, and P− separators, implying the P+ separator enabled a much better reversibility of the Zn plating/stripping process (FIG. 15B-i). After ˜75 h cycling, irregular drops of the voltage started to appear in the curves of GF, UP, and P− separators, indicating the occurrence of localized short-circuit in symmetric cells (FIG. 15B-ii). In contrast, the cell with P+ separator maintained a stable voltage hysteresis throughout the ˜980 h cycling process (FIG. 15B-iii).

SEM at different cycling numbers revealed that the Zn anode with P+ separator remained a consistently flat surface without any dendrite-like or vertical structures (FIG. 16A). Accordingly, the Zn anode exhibited a superior surface smoothness with a Sa of only 0.61 m after 980 h cycling. In contrast, the Zn anodes with GF (FIG. 16B), UP (FIG. 16C), and P− (FIG. 16D) separators were all covered by sharp and vertical plates, which gave large surface roughness at the level of 2-5 μm. This rapid dendritic growth on the Zn anode surface could be responsible for the poor reversibility and quick failure of cell cycling.

Even under a high current density of 5 mA/cm² with a high specific capacity of 5 mAh/cm², the P+ separator still enabled the Zn—Zn cell lifetime of more than 150 h with stable voltage hysteresis. As expected, the P− separator induced a rapid cell failure only after 25 h, attributed to the exacerbation of dendrite growth under an unfavorable internal electric field.

Similar to cycling at 1 mA/cm², the Zn anode with GF, UP, and P− separators showed apparent sharp Zn dendrites and large surface roughness after cycling. Only the P+ separator yielded a consistently flat surface after cycling, although the large-area surface roughness was increased to 2.28 μm because of the fast deposition rate. These electrochemical measurements and morphological observations confirmed that the FE Al₂O₃/P(VDF-TrFE) separator membrane 10 with its positive side facing the metal surface could effectively turn the dendritic growth into a planar growth during the charging process.

Referring to FIGS. 1, 17 and 18, the advantageous P+FE Al₂O₃/P(VDF-TrFE) separator membrane 10 was used in Zn-ions aqueous batteries 16 and compared to commercial GF separators to validate the active dendrite suppression effect. NaV₃O₈·1.5H₂O (NVO) nanowires, a commonly used cathode materials 24 for Zn-ion batteries 16, were selected and coupled with Zn foil anode 22 to assemble the fuel cells 16. The monoclinic NVO nanowires were synthesized in house and appeared in bundles with a typical size of ˜200 nm in thickness and ˜5 μm long. As a control, the same Zn-ion batteries were made using GF separators.

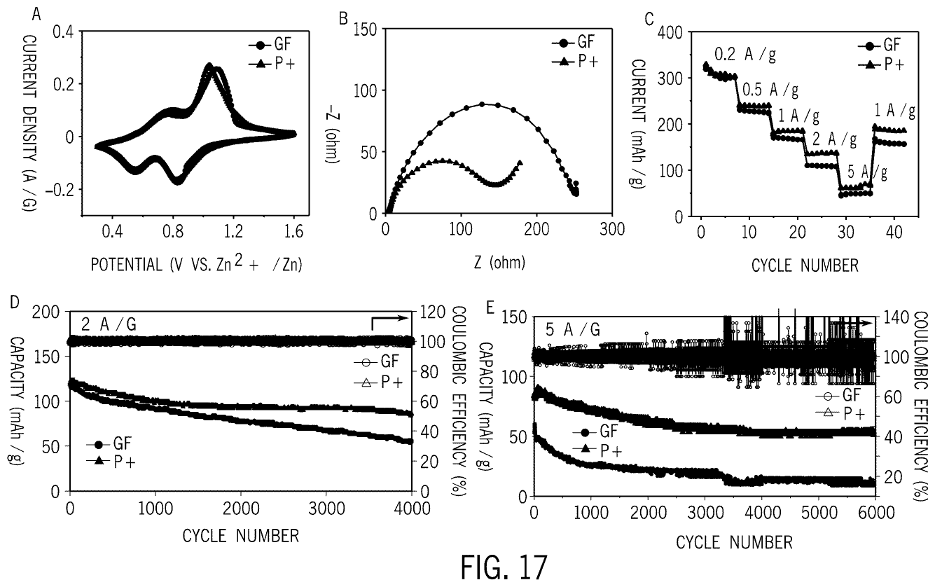

FIG. 17A gives the CV curves of the Zn-NVO cell with P+ and GF separators, respectively. There were two pairs of redox peaks attributed to vanadium valence change from V⁵⁺ to V⁴⁺ and V⁴⁺ to V³⁺ during the Zn²⁺ intercalation/deintercalation. The Zn-NVO cells with GF separator have redox peaks at 0.55/0.79, and 0.83/1.09 V, matching well with the reported results. For the cells with a P+ separator, the redox peaks were located at 0.55/0.76, and 0.82/1.04 V. The slightly negative shift of the oxidation peaks may be attributed to different electrolyte absorption capability of these two separators. Electrochemical impedance spectroscopy (EIS) showed a reduced charge transfer resistance of the P+ separator compared to the GF separator (FIG. 17B), implying a favorable Zn²⁺ ion flux attributed to the mesoporous structure of the FE membrane. The rate capability of Zn-NVO cells with P+ membrane and GF separators are shown in FIG. 17C. At a discharging of 0.2 A/g, both separators achieved a similar discharging capacity of ˜298 mAh/g. As the discharging current increased, the P+ separator preserved a higher capacity compared to the GF separator, demonstrating an enhanced discharging performance.

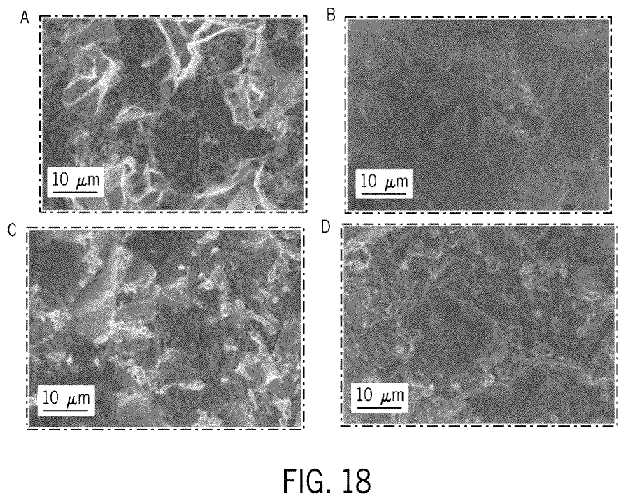

The long-term cycling stability of Zn-NVO cells was evaluated as the most important figure-of-merit for cell performance comparison. After 4000 cycles of discharging/charging under a current of 2 A/g, the Zn-NVO cell with a P+ separator exhibited a specific capacity of ˜88 mAh/g with a retention rate of 71%, while the GF separator only had a retention rate of 48% through the same number of cycles (FIG. 17D). Both cells kept a nearly 100% Coulombic efficiency, suggesting both separators allowed a highly reversible Zn insertion/extraction process. The improvement from the FE P+ separator was more prominent at a high current density of 5 A/g. As shown in FIG. 17E, the full cell with the GF separator had a retention rate of only 19% after 6000 discharging/charging cycles, similar to reported results. At such a high current density, the cells with GF separators exhibited a large fluctuation in its Coulombic efficiency, indicating instability during discharging/charging processes. In contrast, the FE P+ separator allowed a specific capacity of ˜54 mAh/g with a retention rate of 64% after 6000 cycles, still with a substantially stable Coulombic efficiency at ˜100%. SEM images of Zn anode after cycling were collected to justify the suppression effect of Zn dendrites growth. Unlike the aggregated dendritic growth observed from the cells with GF separators under both current densities of 2 A/g and 5 A/g (FIG. 18A, C), the P+ separator effectively suppressed dendrites formation and achieved a substantially flat surface (FIG. 18B, D).

These results confirmed that the FE P+ separator can effectively suppress the dendrite growth during the charging process, and thus enables significant performance improvements of Zn-ions aqueous batteries.

The membrane may be of “piezoelectric” or “ferroelectric” material (ferroelectrics are a subset of piezoelectric materials that possess a spontaneous polarization) and these terms are used interchangeably herein to describe materials that provide an electric field upon external stress being applied.

“Dendrites” refers to non-uniform deposits on an anode surface and may also generally refer to other irregularities such as to whiskers, moss, globules, trees, and cracks.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

1. A battery comprising:
an anode;
a cathode in opposition from the anode; and
a separator separating the anode and the cathode wherein the separator is a mesoporous piezoelectric membrane of piezoelectric material extending along a plane and its polar direction is across the plane wherein a positive polarization is substantially facing the anode and a negative polarization is substantially facing the cathode.

2. The battery of claim 1 wherein the piezoelectric membrane is ferroelectric.

3. The battery of claim 2 where the piezoelectric material has a piezoelectric coefficient d33 value of 1-200 pC/N

4. The battery of claim 1 wherein the mesoporous membrane is P(VDF-TrFE).

5. The battery of claim 4 wherein β-phase is induced in the P(VDF-TrFE).

6. The battery of claim 1 wherein the nanopores are sized to permit transport of liquid electrolyte that carry metal ions.

7. The battery of claim 6 wherein the mesoporous piezoelectric membrane comprises nanopores having an opening size of 10 nm to 10 μm.

8. The battery of claim 6 wherein the nanopores are a size of nanoparticles with a weight ratio of 50-90 wt %.

9. The battery of claim 8 wherein the nanopores are a size of nanoparticles with a weight ratio of approximately 83 wt %.

10. The battery of claim 1 wherein the mesoporous piezoelectric membrane has a thickness of 10-50 μm.

11. The battery of claim 10 wherein the mesoporous piezoelectric membrane has a thickness of approximately 20 μm.

12. The battery of claim 1 wherein the mesoporous piezoelectric membrane is coated with an outer layer of a hydrophilic coating.

13. The battery of claim 11 wherein the hydrophilic coating is Al₂O₃.

14. The battery of claim 1 wherein the anode comprises protrusions extending from the anode toward the cathode.

15. The battery of claim 1 wherein the anode is Zinc metal.

16. The battery of claim 15 wherein the cathode is a sodium vanadium oxide (NaV₃O₈, NVO).

17. A method of suppressing dendrite growth of a battery having an anode, a cathode in opposition from the anode, and a separator separating the anode and the cathode wherein the separator is a mesoporous piezoelectric membrane extending along a plane and poled across the plane wherein a positive polarization is substantially facing the anode and a negative polarization is substantially facing the cathode, the method comprising:
producing an internal electric field near protrusion tips extending toward the cathode surrounded by flat regions of the anode;
repulsing metal ions at the protrusion tips to the flat regions of the anode; and
reducing a growth rate of protrusion tips and increasing a growth rate at the flat regions.

18. The method of claim 17 wherein the mesoporous piezoelectric membrane is ferroelectric and further comprising poling the ferroelectric separator to achieve aligned electrical polarization.

19. A method of suppressing dendrite growth of a battery having an anode, a cathode in opposition from the anode, and a separator separating the anode and the cathode wherein the separator is a mesoporous piezoelectric membrane extending along a plane and poled across the plane wherein a positive polarization is substantially facing the anode and a negative polarization is substantially facing the cathode wherein the anode exhibits inhomogeneity, the method comprising:
producing an internal electric field near protrusions of an anode surface extending toward the cathode surrounded by flat regions of the anode;
repulsing metal ions at the protrusions to the flat regions of the anode; and
reducing the extension of the protrusions and increasing a flatness of the anode surface.

20. The method of claim 19 wherein the mesoporous piezoelectric membrane is ferroelectric and further comprising poling the separator to achieve aligned electrical polarization.
